(19) United States
(12) Patent Application Publication
(10) Pub. No.: US 2020/0057710 A1
(43) Pub. Date: Feb. 20, 2020

(54) SCRIPT GENERATION METHOD FOR MOBILE DEVICE

(71) Applicant: RSUPPORT CO., LTD., Seoul (KR)

(72) Inventor: Tae Soo Jeong, Seoul (KR)

(73) Assignee: RSUPPORT CO., LTD.

(21) Appl. No.: 16/538,181

(22) Filed: Aug. 12, 2019

(30) Foreign Application Priority Data
Aug. 14, 2018 (KR) 10-2018-0094758

(51) Int. Cl. G06F 11/36; G06F 11/34; H04M 1/725

(52) U.S. Cl. CPC G06F 11/3604; H04M 1/72519; G06F 11/3414; G06F 11/3668

(57) ABSTRACT

The present invention relates to a method of creating a script for automatically handling a mobile terminal in the process of testing an application mounted on the mobile terminal such as a smart phone or the like. Through the present invention, an automation script faithfully reflecting the use environment of a mobile terminal can be created, and therefore, effectiveness and reliability of the test of an application program can be dramatically enhanced.

### CROSS-REFERENCE TO RELATED APPLICATION

This application claims priority to Korean Application No. 10-2018-0094758 filed Aug. 14, 2018, which is incorporated herein by reference.

### TECHNICAL FIELD

The present invention relates to a method of creating a script for automatically handling a mobile terminal 10 in the process of testing an application mounted on the mobile terminal 10 such as a smart phone or the like, in which an authoring program mounted on the mobile terminal 10 extracts actual handling information of a user and information on a screen outputted according thereto, creates and stores the script on the basis of the screen information, and attaches information on a situation of the mobile terminal 10 at a corresponding time point.

### RELATED ART

Mobile terminals 10 such as a smart phone, a table computer and the like equipped with a high-performance processing device, a large-capacity memory device and a high-definition touch screen are utilized as a multi-function information device in which various application programs are executed, rather than as a simple communication device, and therefore, various application programs operating under the operating system of the mobile terminals 10 are developed.

In addition, as application program manufacturing environments are widely open by manufacturers of mobile terminal 10 operating systems, manufacturing the application programs, which was the exclusive property of mobile terminal 10 manufacturers or communication companies in the past, is expanded to general users, as well as small and medium program development companies, and quantitative and qualitative growth of application programs for mobile terminals 10 is achieved explosively.

Like other software, the application programs for mobile terminals 10 also go through a test to examine operational errors, stability and compatibility of the applications as the final step of production, and as a method of testing the application programs, a method of executing and controlling an application program mounted on a mobile terminal 10 is generally used by allowing a test program mounted on a computer to automatically control the mobile terminal 10 while a data connector of the mobile terminal 10, such as a universal serial bus (USB) or the like, is physically connected to the computer, and a related conventional technique is disclosed in Korean Laid-opened Patent No. 2012-121950.

Automatic handling of the computer on the mobile terminal 10 on which an application program to be tested is mounted is performed as a test program mounted on the computer transmits a script corresponding to individual handling to the mobile terminal 10, and a database in which scripts of various scenarios for handling an application program to be tested are recorded is constructed in the computer in which a test program is driven, and a test may be automatically performed in various situations although a tester does not handle the mobile terminal 10 by himself or herself.

Like this, application programs of a mobile terminal 10 can be automatically tested using a computer, on which a test program is mounted, and scripts of various situations. However, there is a problem in that the mobile terminal 10 and the computer should be physically connected, and various types of mobile terminals 10 cannot be tested simultaneously.

Therefore, as test programs executed in a mobile terminal 10, not in a computer, are developed, application programs of the mobile terminal 10 can be automatically tested without physically connecting the mobile terminal 10 and the computer, and a related conventional technique is disclosed in Korean Laid-opened Patent No. 2009-78890.

### SUMMARY

Regardless of whether it is a test of an application program performed by connecting a mobile terminal 10 and a computer as shown in Korean Laid-opened Patent No. 2012-121950 or a test of an application program performed by a test program mounted on the mobile terminal 10 itself as shown in Korean Laid-opened Patent No. 2009-78890, a series of processes for executing and controlling an application program are performed by a script corresponding to a behavior of handling the mobile terminal 10.

That is, as a test program or an operating system of the mobile terminal 10 reads a script created in advance and treats the script as input handling on an application program mounted on the mobile terminal 10, instead of directly handling a physical input device of the mobile terminal 10 to execute and control the application program, the application program to be test is automatically executed and tested.

Accordingly, creation of a test script should be preceded for automatic test of an application program of a mobile terminal 10, and the test script is mainly created by a developer of an application to be tested or an expert requested to test the application program.

Although creating a test script of an application program of a mobile terminal 10 by a developer or a related expert may be regarded as advantageous at first sight from the aspect of reliability, accuracy and efficiency of the test, as the expertise of a script creator creates an artificial environment alienated from an actual operating environment of the application program in reality, a side effect giving a negative influence to the reliability and effect of the test is invited.

That is, a script used in an automatic test method of an application program of a mobile terminal 10 is created by an expert in the field of information technology, and although integrity and stability of the script itself are excellent, since an actual user of an application program distributed after a test is completed is an ordinary person, not an expert, in most cases, mishandling or unnecessary meaningless handling frequently occurs in handling the application program in an actual use environment, and accordingly, a script neatly organized by an expert does not reflect the actual use environment and does not predict at all an error that can be occurred by the mishandling or the meaningless handling, and thus the test effect of the application program is halved.

Therefore, although errors occurred in an unexpected situation are confirmed by mounting a random handling script, which is called as a Monkey script or the like, on the operating system of the mobile terminal 10 or a development tool and randomly and automatically handling the mobile terminal 10 on which an application to be tested is mounted, this is the same as handling the mobile terminal 10 by a monkey in a state completely excluding sequential and systematic handling based on minimum intellectual determination, like the meaning of the Monkey script as is defend in a dictionary, and thus this also may not be regarded as automatic handling which reflects an actual use environment.

Particularly, since random handling like this is progressed in a method of repeatedly executing a script of touching arbitrary coordinates on a touch screen of the mobile terminal 10, when an application program to be tested operates in a method of being sequentially executed according to touch, the test is practically impossible to perform since the number of cases of being executed increases exponentially, and although it is possible to conduct the test, a meaningful test result cannot be expected.

Meanwhile, since a script used in a conventional technique reflects only details of handling and does not reflect at all a situation of the mobile terminal 10 in which the script is executed, i.e., a communication network, a location, or whether various sensors are activated, there is a limit in the reliability and accuracy of a test result, and in addition, there is a serious problem in the efficiency.

As the field of utilizing the mobile terminal 10 is expanded and the functions of the mobile terminal 10 are sophisticated, application programs also become complicated and sophisticated, and in addition, communications are actively performed and, at the same time, various ambient sensing signals, as well as location information, are used in the process of executing the application programs, and since scripts used in conventional application program tests are based on user's handling, there is a problem in that surrounding situations are not reflected practically, and experiment conditions are not reproduced faithfully.

For example, in the case of an application program which uses location information based on GPS information as an initial value or an input value when a program is executed, a conventional test script only reproduces user's handling and does not practically reflect whether the location information is acquired at a corresponding time point or the location information itself, and accordingly, when an error occurs due to lack of the location information in the test process, it takes a long time in identifying a cause of the error.

In addition, similar problems may occur in a test of an application program performed assuming that a communication network is connected or in a test of an application program which consumes output signals of various sensors.

In view of the problems as described above, the present invention has been made to create a script which can faithfully reproduce handling of a general user while sufficiently reflecting an actual use situation in a general use environment and, at the same time, enhance the accuracy, reliability and efficiency in a test of an application program of a mobile terminal 10 by recording situation information expressing a location, a communication network connection state and the like all together, and there is provided a method of creating a script for the mobile terminal 10, in a situation information attaching-type actual use-based mobile terminal script creation method, the method comprising: an execution step (S10) of executing an authoring program mounted on the mobile terminal 10; a screen extraction step (step S21) of extracting screen information of the mobile terminal 10 from a screen analyzer, by the authoring program; a situation extraction step (step S22) of extracting situation information including time point information, communication information or location information from an operating system of the mobile terminal 10, by the authoring program; a handling extraction step (step S23) of extracting handling information from an event analyzer, by the authoring program, when input handling is accomplished; a creation step (S31) of creating the script on the basis of the screen information and the handling information, by the authoring program; and a storage step (S32) of storing the created script and situation information corresponding to the script in a memory device of the mobile terminal 10, by the authoring program.

In addition, the execution step (step S10) is performed as a start icon 21 on a screen of the mobile terminal 10 is touched, and the execution step (step S10) is performed as a status bar on the screen of the mobile terminal 10 is spread and touched.

### BRIEF DESCRIPTION OF THE DRAWINGS

FIG. 1 is a view showing the system configuration of a mobile terminal in which the present invention is performed.

FIG. 2 is a view showing a script creation method of the present invention.

FIG. 3 is a flowchart of the present invention.

FIG. 4 is a view showing an example of a mobile terminal screen in which the present invention is performed.

FIG. 5 is a view showing an example of a mobile terminal screen of a status bar-type embodiment of the present invention.

### DESCRIPTION OF SYMBOLS

10: Mobile terminal
21: Start icon
22: Termination icon
S10: Execution step
S21: Screen extraction step
S22: Situation extraction step
S23: Handling extraction step
S31: Creation step
S32: Storage step

### DETAILED DESCRIPTION

The detailed configuration of the present invention and a process of performing the same will be described with reference to the accompanying drawings.

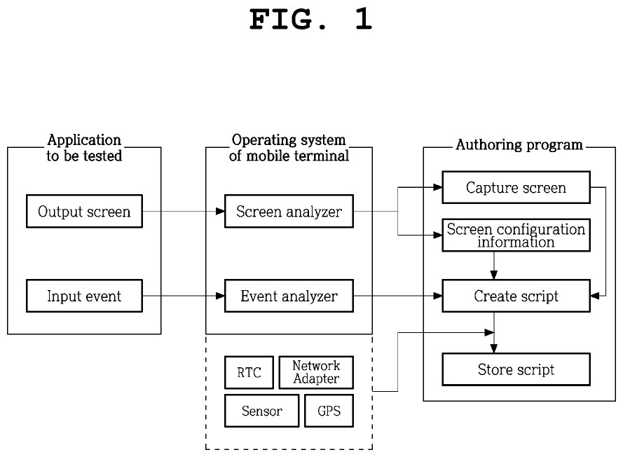

First, FIG. 1 is a view showing the system configuration of a mobile terminal 10 in which the present invention is performed, and the system is configured of an operating system of the mobile terminal 10, an application program to be tested as an application program of the operating system, and an authoring program practically performing the present invention.

The authoring program performing the present invention is a program connected to a screen analyzer and an event analyzer, which are program modules of the operating system of the mobile terminal 10, and performing a function of extracting screen information and handling information from the analyzers, creating a script code on the basis of the information, and extracting situation information such as a time, a communication network connection state, a location and the like from the operating system, and the authoring program like this is also installed as an application program of the operating system of the mobile terminal 10.

In the present invention, the situation information is information expressing an operation situation of the mobile terminal 10 as is defined by a dictionary, which is extracted from the operating system of the mobile terminal 10 by the authoring program and is configured of time point information, communication information, location information, and sensing information.

Here, the time point information is information extracted from the operating system of the mobile terminal 10 and has a character string or numeric string format expressing a real time at a corresponding time point, and the communication information is information expressing a connection state of a communication network, i.e., whether a wireless LAN is connected, whether a mobile communication is connected, or a name of a connected network.

In addition, the location information is information expressing the coordinates of the mobile terminal 10 extracted from a GPS module or the like of the mobile terminal 10, and the sensing information is information expressing signals outputted from various sensors, such as an acceleration sensor, a gravity sensor, a proximity sensor and the like mounted on the mobile terminal 10.

An operation state or a surrounding situation of the mobile terminal 10 may be correctly grasped through the situation information, such as the time point information, the communication information, the location information, and the sensing information like this, and as situation information corresponding to an individual script is recorded in a memory device of the mobile terminal 10, together with the script, at a storage step (step S32) described below, an actual handling situation may be faithfully and correctly implemented in reproducing handling of the mobile terminal 10 by using the script in the process of testing an application program in the future.

As described above, although a major object of the present invention is creating a script for automatically handling an application program to be tested, since the application program to be tested is only executed by handling of a user in this process and may not be involved in creating the script at all, the application program to be tested and the authoring program performing the present invention operate to be independent from each other, and furthermore, only the authoring program may independently operate regardless of execution of the application program to be tested.

That is, it is not that the authoring program is executed assuming that the application program to be tested operates, and the application program to be tested is executed only for the purpose of inducing user's handling for creating a script that can be used for automatic test of the application program to be tested, and accordingly, if the user's handling is performed after the authoring program is executed, a script sufficiently reflecting the user's handling situation may be created regardless of whether the application program to be tested is executed.

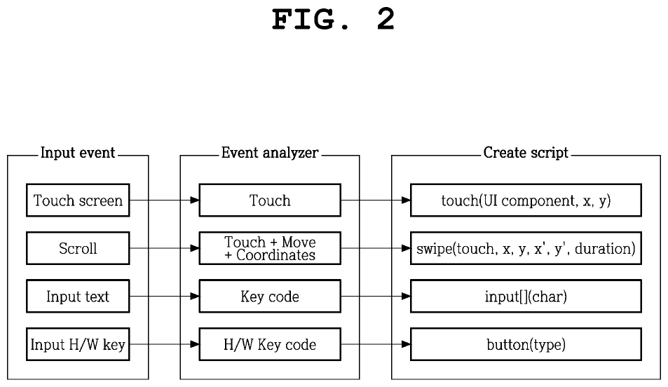

FIG. 2 is a view specifically showing a method of creating a script by an authoring program executed to be independent from an application program to be tested as described above, which illustrates a process of reading user's handling, i.e., an input event, and creating handling information by the event analyzer as the user's handling is generated, and extracting the created handling information and creating a script code by the authoring program, and a series of script codes created like this are recorded in the memory device of the mobile terminal 10, together with the situation information, in the form of a script file or the like.

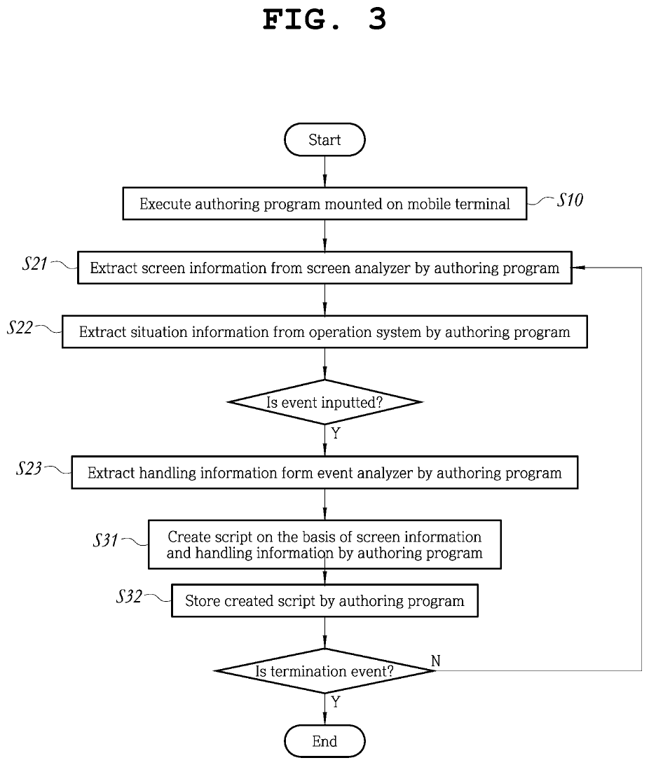

FIG. 3 is a flowchart illustrating the entire process of the present invention, and as shown in the figure, the present invention begins by performing an execution step (step S10) of executing an authoring program mounted on the mobile terminal 10.

Then, a screen extraction step (step S21) of extracting screen information of the mobile terminal 10 from the screen analyzer of the operating system of the mobile terminal 10 by the authoring program mounted on the mobile terminal 10 is performed, and the screen information extracted at the screen extraction step (step S21) includes Graphical User Interface (GUI) components such as widgets and the like, screen configuration information including screen specification elements such as a resolution, an aspect ratio and the like, and captured images.

In addition, a situation extraction step (step S22) of extracting situation information including time point information, communication information and location information from the operation system of the mobile terminal 10 by the authoring program is performed, and here, the situation information is information configured of the time point information, the communication information, the location information, and the sensing information as described above, which may be regarded as information faithfully recording a real situation at a corresponding time point of the mobile terminal 10.

Meanwhile, as the screen extraction step (step S21) and the situation extraction step (step S22) are repeatedly performed when a change occurs in the screen information or the situation information, the screen information and the situation information of a state updated according to the script may be recorded at the storage step (step S32) described below.

Then, when a gesture input is performed through the touch screen of the mobile terminal 10 or hardware key handling, i.e., input handling, of the mobile terminal 10 is performed by the user, a handling extraction step (step S23) of extracting handling information from the event analyzer by the authoring program is performed.

The authoring program may correctly and specifically grasp the handling situation of the mobile terminal 10 of the user through the steps from the screen extraction step (step S21) to the handling extraction step (step S23), and a series of handling performed at a corresponding time point is created in the form of a script code by performing a creation step (step S31) of creating a script by the authoring program on the basis of the screen information and the handling information.

As the storage step (step S32) of storing the script created by the authoring program and the situation information corresponding to the script in the memory device of the mobile terminal 10 is performed, a series of script codes created like this is completed as a script file as a series of sequentially accumulated control information.

That is, in the present invention, the script file is not character string information simply arranging scripts in a sequence, but is established as information of a form recording situation information, together with a script, for each script at the time point of creating the script.

The script file created through the process like this is provided to a test manager who has distributed the application program to be tested or the script file is distributed to a plurality test participants so that a series of user's handling described above may be faithfully reproduced, and particularly, as the situation information is provided for each script, the accuracy, reliability and efficiency can be dramatically enhanced.

That is, an operation situation of the mobile terminal 10 at the time point of creating each script can be faithfully reflected in a test performed thereafter, and it is not simply reproducing only the user's handling, but an actual time, a communication network connection state, a location, signals of various sensors or the like at the time point of performing corresponding user's handling may be faithfully reflected in a test.

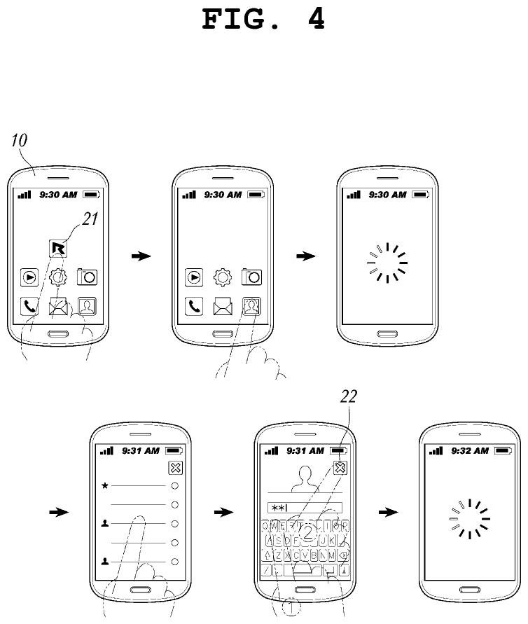

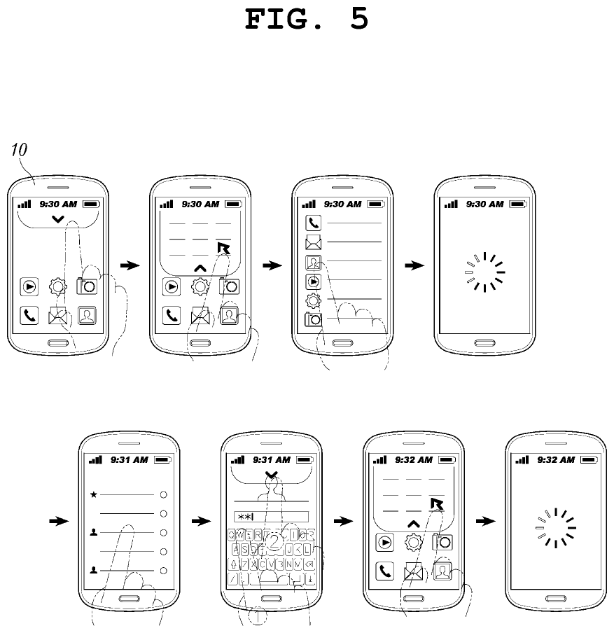

Meanwhile, start and end of the present invention may be execution and termination of the authoring program, and since the execution and termination of the authoring program should be determined according to the intention of the user, a means for enforcing the execution and termination of the authoring program is needed, and an example thereof is shown in FIGS. 4 and 5.

FIG. 4 is a view showing an example of starting and terminating an authoring program by touching an icon implemented on the touch screen of the mobile terminal 10, and in this case, the execution step (step S10) described above is performed as a start icon 21 on the screen of the mobile terminal 10 is touched.

In addition, termination of the authoring program, i.e., termination of creating a script, may also be performed through a touch on the termination icon 22 as shown in FIG. 4, and to this end, once the authoring program is executed, the termination icon 22 is implemented on the screen of the mobile terminal 10.

Although the icon handling method like this may obtain an effect of expanding distribution of the present invention since even a user inexperienced in using a mobile terminal 10 may intuitively handle the mobile terminal 10, since the termination icon 22 is displayed on the screen at all times while the authoring program is executed, there is a problem in that the termination icon 22 may be confused with other icons and mishandling of the icon is worried.

Therefore, in the present invention, in a method of adding an item for activating the authoring program in the status bar as shown in FIG. 5, the present invention can be performed without displaying the start icon 21 and the termination icon 22 on the screen of the mobile terminal 10 at normal times and while the authoring program is executed.

That is, as shown in FIG. 5, the execution step (step S10) is performed after the status bar on the screen of the mobile terminal 10 is spread and touched, and termination of the authoring program may also be performed thereafter by handling the status bar in the same way.

Through the present invention, an automation script faithfully reflecting the use environment of a mobile terminal 10 can be created, and therefore, since an actual use state can be perfectly reproduced in a test of an application program mounted on the mobile terminal 10, effectiveness and reliability of the test of an application program can be dramatically enhanced.

In addition, since meaningless random and repetitive handling can be excluded in the automatic test process of an application program of the mobile terminal 10, the speed and efficiency of the test can be secured, and since consumption of electronic computing resources of the mobile terminal 10 accompanied in the test process can be lowered, the cost required for the test can be reduced.

Particularly, since situation information such as a location of the mobile terminal 10, a communication network and the like that has been overlooked in the conventional techniques is faithfully reflected, the accuracy, reliability and efficiency can be enhanced in the test of an application program of the mobile terminal 10.

What is claimed is:

1. A method of creating a test script of a mobile terminal on which an application program to be tested is mounted, in a situation information attaching-type actual use-based mobile terminal script creation method, the method comprising:
an execution step (step S10) of executing an authoring program mounted on the mobile terminal and operating to be independent from the application program to be tested;
a screen extraction step (step S21) of extracting screen information of the mobile terminal from a screen analyzer, by the authoring program mounted on the mobile terminal;
a situation extraction step (step S22) of extracting situation information including time point information, communication information or location information from an operating system of the mobile terminal, by the authoring program mounted on the mobile terminal;
a handling extraction step (step S23) of extracting handling information from an event analyzer, by the authoring program mounted on the mobile terminal, when input handling by a user is accomplished;
a creation step (step S31) of creating the script on the basis of the screen information and the handling information extracted at the handling extraction step (step S23), by the authoring program mounted on the mobile terminal; and
a storage step (step S32) of storing the created script and situation information corresponding to the script in a memory device of the mobile terminal, by the authoring program mounted on the mobile terminal.

2. The method according to claim 1, wherein the execution step (step S10) is performed as a start icon on a screen of the mobile terminal is touched.

3. The method according to claim 1, wherein the execution step (step S10) is performed as a status bar on a screen of the mobile terminal is spread and touched.
